(19) United States
(12) Patent Application Publication
(10) Pub. No.: US 2010/0236090 A1
(43) Pub. Date: Sep. 23, 2010

(54) Multilayer Plastic Container and Method of Storing Lyophilized Products

(76) Inventor: Michael J. Grimm, Sylvania, OH (US)

Correspondence Address: REISING, ETHINGTON, BARNES, KISSELLE, P.C., P.O. BOX 4390, TROY, MI, 48099-4390, US

(21) Appl. No.: 12/791,229

(22) Filed: Jun. 1, 2010

Related U.S. Application Data
(62) Division of application No. 11/888,549, filed on Aug. 1, 2007.

(51) Int. Cl. F26B 5/06; B65D 81/26; B65D 30/02

(52) U.S. Cl. 34/296; 206/204; 206/524.6; 383/113

(57) ABSTRACT

A multilayer plastic container for storing lyophilized products includes at least three layers consisting of inner and outer layers having a moisture vapor transmission rate of not more than 0.1 gm mil/100 sq. in.-day at 73° F. and 95% rh, and an intermediate layer of hygroscopic resin construction having a moisture content less than 1000 ppm. The hygroscopic intermediate layer preferably comprises at least 30% of the total thickness of the three layers. The inner and outer layers preferably are of cyclic olefin polymer or cyclic olefin copolymer construction, and the hygroscopic intermediate layer preferably is of amorphous nylon construction. The container preferably is empty and sealed within a secondary container, such as a metallized bag, that is impervious to moisture.

This application is a division of application Ser. No. 11/888,549 filed Aug. 1, 2007.

The present disclosure relates to a multilayer plastic container for storing lyophilized products and to a method of using such a container.

### BACKGROUND AND SUMMARY OF THE DISCLOSURE

Lyophilized or freeze-dried products such as medical products typically are stored in Type 1 glass containers or vials, which have very low moisture vapor transmission rates that keep the lyophilized cake intact. Plastic containers, although less expensive and more rugged than glass containers, typically have not been employed for storing lyophilized products because of the higher moisture vapor transmission rates of typical plastic containers. A general object of the present disclosure is to provide a plastic container suitable for long-term storage of lyophilized products, and to provide a method of storing lyophilized products in such a container.

The present disclosure embodies a number of aspects that can be implemented separately from or in combination with each other.

A multilayer plastic container for storing lyophilized products, in accordance with one aspect of the present disclosure, includes at least three layers consisting of inner and outer layers having a moisture vapor transmission rate of not more than 0.1 gm mil/100 sq. in.-day at 73° F. and 95% rh, and an intermediate layer of hygroscopic resin construction having a moisture content less than 1000 ppm. The hygroscopic intermediate layer preferably comprises at least 30% of the total thickness of the three layers. The inner and outer layers preferably are of cyclic olefin polymer or cyclic olefin copolymer construction, and the hygroscopic intermediate layer preferably is of amorphous nylon construction. The container preferably is empty and sealed within a secondary container, such as a metallized bag, that is impervious to moisture.

A method of storing a lyophilized product, in accordance with a second aspect of the present disclosure, includes providing a multilayer plastic container having first and second layers with moisture vapor transmission rates of not more than 0.1 gm mil/100 sq. in.-day at 73° F. and 95% rh, and a third layer between the first and second layers of hygroscopic plastic construction having a moisture content of less than 1000 ppm. The multilayer plastic container is stored in a low humidity environment, such as within a sealed metallized bag. At the time of use, the container is removed from the low humidity environment, a product is placed within the container and the product is lyophilized. The hygroscopic third layer of the container functions as a desiccant to absorb any moisture transmitted through the first and second layers.

### BRIEF DESCRIPTION OF THE DRAWINGS

The disclosure, together with additional objects, features, advantages and aspects thereof, will best be understood from the following description, the appended claims and the accompanying drawings in which:

FIG. 1 is a sectioned elevational view of a container for storing lyophilized products in accordance with an exemplary embodiment of the present disclosure; and

FIG. 2 is a graphic illustration of tests performed on the container of FIG. 1.

### DETAILED DESCRIPTION OF PREFERRED EMBODIMENTS

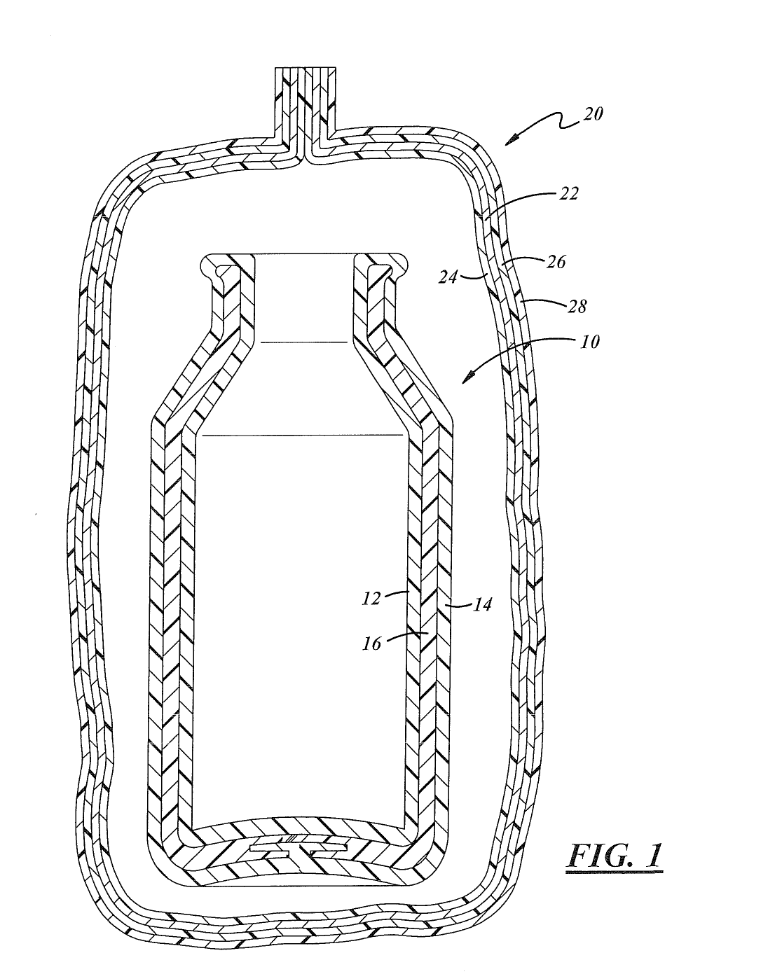

FIG. 1 illustrates a container 10 in accordance with an exemplary embodiment of the present disclosure. Container 10 is a multilayer plastic container that includes at least inner and outer or first and second plastic layers 12,14 and an intermediate or third plastic layer 16. There can be additional layers inside of inner layer 12, outside of outer layer 14 and/or between layers 12,14. Multilayer container 10 can be fabricated employing any suitable technique, such as injection molding, extrusion blow molding, injection blow molding or reheat blow molding. Inner and outer layers 12,14 preferably have a relatively low moisture vapor transmission rate of not more than 0.1 gm mil/100 sq. in.-day at 73° F. and 95% rh. Intermediate layer 16, preferably is hygroscopic and has a moisture content less than 1000 ppm. Intermediate layer 16 preferably both is hygroscopic and provides a barrier to transmission of gases such as oxygen.

In an exemplary embodiment of the present disclosure, inner and outer layers 12,14 of container 10 are of cyclic olefin polymer construction such as Zeon COP or cyclic olefin copolymer construction such as Ticona COC. Intermediate layer 16 preferably comprises at least 30% of the total thickness of layers 12,14,16, and most preferably is of amorphous nylon construction such as EMS G-21. Amorphous nylon is hygroscopic and provides a barrier to oxygen transmission. As purchased, amorphous nylon typically has a moisture content less than 200 ppm. Further processing prior to container manufacture can reduce this moisture content to less than 50 ppm.

After manufacture, empty container 10 preferably is stored in a low-humidity environment, such as sealed within a secondary container 20 that is impervious to moisture. Secondary container 20 preferably comprises a metallized bag having a metal layer 22 of aluminum for example sandwiched within layers 24,26,28 of plastic construction. A presently preferred secondary container 20 is marketed by Ludlow Coated Products, product FR-2175-B having an outer layer 28 of oriented polypropylene, a layer 26 of polyethylene, a metal foil layer 22 and an inner layer 24 of low density polyethylene. Other metallized bags and secondary containers can be employed.

When ready for use, container 10 is removed from secondary container 20 and the product is placed within the container. The product is lyophilized and the container is sealed. Container layers 12,14 resist transmission of moisture vapor into the container. Hygroscopic intermediate layer 16 resists transmission of oxygen and other gases into the container. Furthermore, the hygroscopic intermediate layer acts as a desiccant to absorb any moisture that is transmitted through layer 14, and indeed draws any moisture remaining within container 10 through layer 12 and absorbs this moisture. Hygroscopic layer 16 thus acts as a scavenger of any moisture that permeates through layer 14, and maintains a low relative humidity across layer 12 reducing the amount of moisture that enters the product and extending the shelf life of the product.

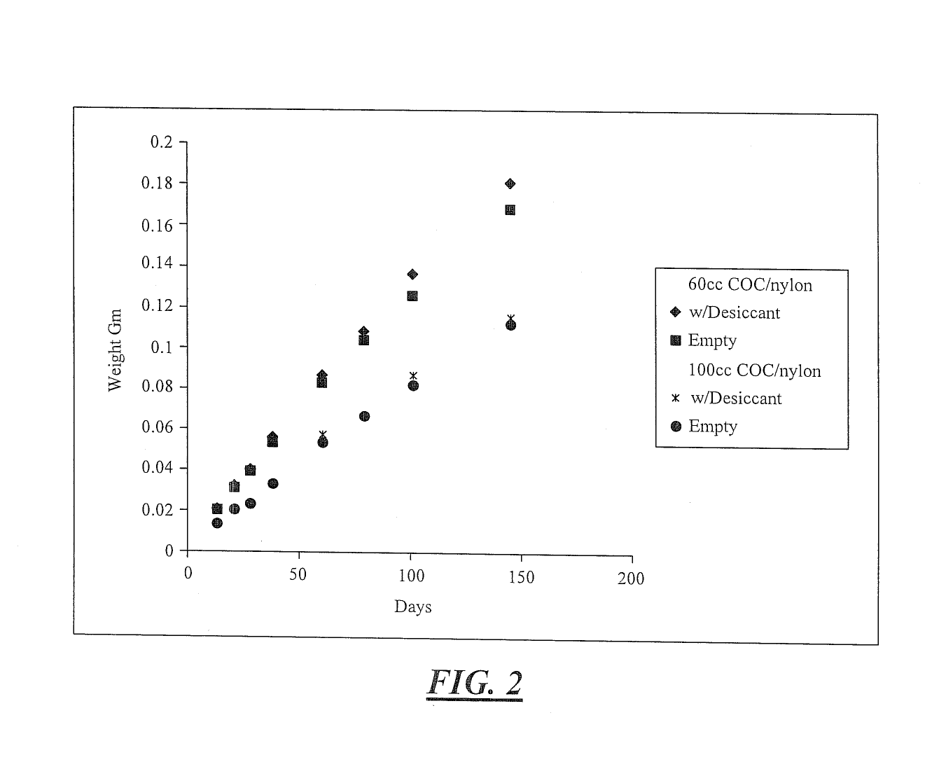

FIG. 2 illustrates results of tests performed on a 60 cc container 10 and a 100 cc container 10. In each container, layers 12,14 were of Ticona cyclic olefin copolymer construction and intermediate layer 16 was of EMS G-21 amorphous nylon construction. In each container, intermediate layer 16 constituted about 30% of the total sidewall thickness. Sealed containers with and without desiccant were placed in a test chamber at 75% relative humidity and 23° C. FIG. 2 demonstrates that, after up to 150 days, there was no significant weight gain difference between the containers filled with desiccant and the empty containers.

There thus has been disclosed a multilayer plastic container and a method of use for storing lyophilized products that fully achieve all of the objects and aims previously set forth. The disclosure has been presented in conjunction with an exemplary embodiment, and modifications and variations have been discussed. Other modifications and variations readily will suggest themselves to persons of ordinary skill in the art in view of the foregoing discussion. The disclosure is intended to encompass all such modifications and variations as fall within the spirit and broad scope of the appended claims.

1. A method of storing a lyophilized product, which includes the steps of:
(a) providing a multilayer plastic container that includes first and second plastic layers having a moisture vapor transmission rate of not more than 0.1 gm mil/100 sq. in.-day at 73° F. and 95% rh, and a third plastic layer between said first and second layers of hygroscopic plastic construction and having a moisture content less than 1000 ppm,
(b) storing said container in a low humidity environment,
(c) removing said container from said low humidity environment,
(d) placing a product within said container, and then
(e) lyophilizing said product, after which said hygroscopic third layer functions as a desiccant to absorb any moisture transmitted through said first and second layers.

2. The method set forth in claim 1 wherein said step (b) is carried out by placing said container in a metalized bag.

3. The method set forth in claim 2 wherein said hygroscopic third layer comprises at least 30% of the total thickness of said first, second and third layers.

4. The method set forth in claim 3 wherein said first and second layers are of cyclic olefin polymer or cyclic olefin copolymer construction and said third layer is of amorphous nylon construction.

5. The method set forth in claim 4 wherein said amorphous nylon third layer has a moisture content less than 200 ppm following said step (a).

6. The method set forth in claim 5 wherein said amorphous nylon third layer has a moisture content less than 50 ppm following said step (a).

7. A multilayer plastic container that includes at least three plastic layers consisting of inner and outer layers having a moisture vapor transmission rate of not more than 0.1 gm mil/100 sq. in.-day at 73° F. and 95% rh, and an intermediate layer of hygroscopic plastic construction having a moisture content less than 1000 ppm.

8. The container set forth in claim 7 wherein said intermediate hygroscopic layer comprises at least 30% of the total thickness of said three layers.

9. The container set forth in claim 8 wherein said inner and outer layers are of cyclic olefin polymer or cyclic olefin copolymer construction, and said hygroscopic intermediate layer is of amorphous nylon construction.

10. The container set forth in claim 9 wherein said amorphous nylon intermediate layer has a moisture content less than 200 ppm.

11. The container set forth in claim 10 wherein said amorphous nylon intermediate layer has a moisture content less than 50 ppm.

12. The container set forth in claim 7 wherein said container is empty and is sealed within a secondary container that is impervious to moisture.

13. The container set forth in claim 12 wherein said secondary container is a metalized bag.
